(19) United States
(12) Patent Application Publication
(10) Pub. No.: US 2019/0012929 A1
(43) Pub. Date: Jan. 10, 2019

(54) INTERACTIVE INCENTIVE BASED GAME BOARD SYSTEM AND METHOD OF USE

(71) Applicant: Kenneth J. Manninen, Fond Du Lac, WI (US)

(72) Inventor: Kenneth J. Manninen, Fond Du Lac, WI (US)

(21) Appl. No.: 15/641,375

(22) Filed: Jul. 5, 2017

(51) Int. Cl. G09B 19/00; B43L 1/00; G09B 5/00; A63F 3/00; A63F 3/04

(52) U.S. Cl. CPC G09B 19/00; B43L 1/00; A63F 3/04; A63F 3/00643; G09B 5/00

(57) ABSTRACT

Embodiments described herein provide an interactive incentive based game board system which provides a visual reward system for children having a plurality of accumulation scales which contain a plurality of light emitting diodes which are configured to illuminate and provide an audio alert when an accumulation balance has changed. Simultaneously, a visual indication will be provided within the scale in a vertical direction opposite the baseline. The scales configured between zero and twenty-five may be adjusted in both the positive and negative directions and allow for infinite accumulation. The system further includes an earning, purchases, and fines ledger where a variety of pre-determined tasks may be categorized to identify what is incentivized activities.

### CROSS-REFERENCE TO RELATED APPLICATION

This Continuation-In-Part (CIP) application claims priority to the pending Non-Provisional patent application Ser. No. 13/368,050 “System and Method For Tracking User Defined Parameters” filed on Feb. 7, 2012, by Kenneth J. Manninen.

### FIELD

The embodiments presented relate to an interactive incentive based game board system and method of use, and an interactive reward based board game system and method of use which allows a user to selectively input and track a plurality of user defined rewards and penalties onto an interactive board game over a period of time and at least receive an audio and visual feedback of the accumulated balance.

### BACKGROUND

Games and toys are increasingly utilizing computer processors and other technologies which have become smaller and more inexpensive than ever to enhance the playing experience and incorporate player interactivity into the devices. More recent gaming devices utilize embedded sensors to allow for human interaction to alter responses by the game or toy and permit corresponding outputs in conjunction therewith. The adaptability and variability of these computer processors and sensors allow for games that can better simulate real-life dilemmas, trade-offs, and situations.

While there are some computer-based games which utilize sensors, electronic displays, or push-buttons to create an experience where the user can affect the gameplay through the player's actions, many of these such games fail to include an opportunity for substantial tactile input that has become the cornerstone and draw board games. Board games often feature tangible, movable pieces, a three-dimensional space for gameplay, and the requirement of physical manipulation of the same by the players. This physical interaction is valuable and desirable for children and adults alike to stimulate learning and other brain activity. Typical board games, however, are limited to the ability, creativity, or number of the players involved. Further, they lack the variety that newer computer processors can offer by virtue of their computing power and independent responsiveness when combined with standard electronic outputs.

Thus, there exists a need for a board game which utilizes both the three-dimensional game space, tactile, and human interactive features dominant in standard board game play, and the independent processing, computing, and responsiveness available with modern computer processors to create a game that allows for substantial and variable tactile human input and provides auditory and visual outputs to simulate rewards, incentives, and penalties.

### SUMMARY OF THE INVENTION

Embodiments described herein provide an interactive incentive based game board system and method of use which allows a user to interact with a plurality of tactile inputs about the board electrically connected to at least one capacitive sensor and receive a visual indication of an accumulated balance based on user defined parameters which further correspond to at least one earning (i.e., incentive), purchases (i.e., penalty), and fine (i.e., penalty). The system includes a processor and memory module electrically connected to at least one capacitive sensor and plurality of vertically oriented light emitting diodes which illuminate through a translucent portion of the top surface of the game board based on accumulated balance of earning, purchases, and/or fines in a vertical direction away from the baseline zero.

The game board may be further personalized to the user by allowing the user to releasably attach a photograph to the top surface. Further included onto the top surface of the game board is an “earning” ledger, “purchases” ledger, and fines “ledger” (i.e., parameters) which allow the user to further define a specific action/task within each ledger at a dry erase portion of the game board. Once the parameters are defined, the user may accumulate a balance by releasably depressing a pushbutton located adjacent to each of the vertically oriented parameter lights at the end of a defined period of time, the user may then tally the accumulated balance at the visual indicator for each of the parameters and write the accumulated balance onto the dry erase portion of the board and reset the balance by depressing a “clear” pushbutton.

Other aspects, advantages, and novel features of the embodiments will become apparent from the following detailed description in conjunction with the drawings.

### BRIEF DESCRIPTION OF THE DRAWINGS

A more complete understanding of the embodiments, and the attendant advantages and features thereof, will be more readily understood by reference to the following detailed description when considered in conjunction with the accompanying drawings wherein:

FIG. 1 is a view of an interactive incentive based game board system;

FIG. 2 is a perspective view the system;

FIG. 3 is detailed view of the system during use;

FIG. 4 is a view of the game board system illustrating a method of accumulating earnings;

FIG. 5 is a view of the game board system illustrating the accumulation of both earning and fines; and

FIG. 6 is a detailed view of a bank ledger of the game board system.

### DETAILED DESCRIPTION

The specific details of the single embodiment or variety of embodiments described herein are set forth in this application. Any specific details of the embodiments are used for demonstration purposes only, and no unnecessary limitation or inferences are to be understood therefrom. Furthermore, as used herein, relational terms, such as “first” and “second,” “top” and “bottom,” and the like, may be used solely to distinguish one entity or element from another entity or element without necessarily requiring or implying any physical or logical relationship, or order between such entities or elements.

The embodiments shown are directed toward an interactive incentive based game board system which allows a user to track and visual an accumulated balance in both the positive and negative directions based a user define parameters. The system includes a microprocessor electrically connected to a memory module and capacitive sensors which are configured to sense when one of the plurality of push-buttons is depressed and provide a visual indication of the change in the accumulated balance using twenty-five increment visual indicator scales comprised of light emitting diodes which are illuminated through a translucent portion of the game board. The system further includes a dry-erasable game board having at least a ledger which

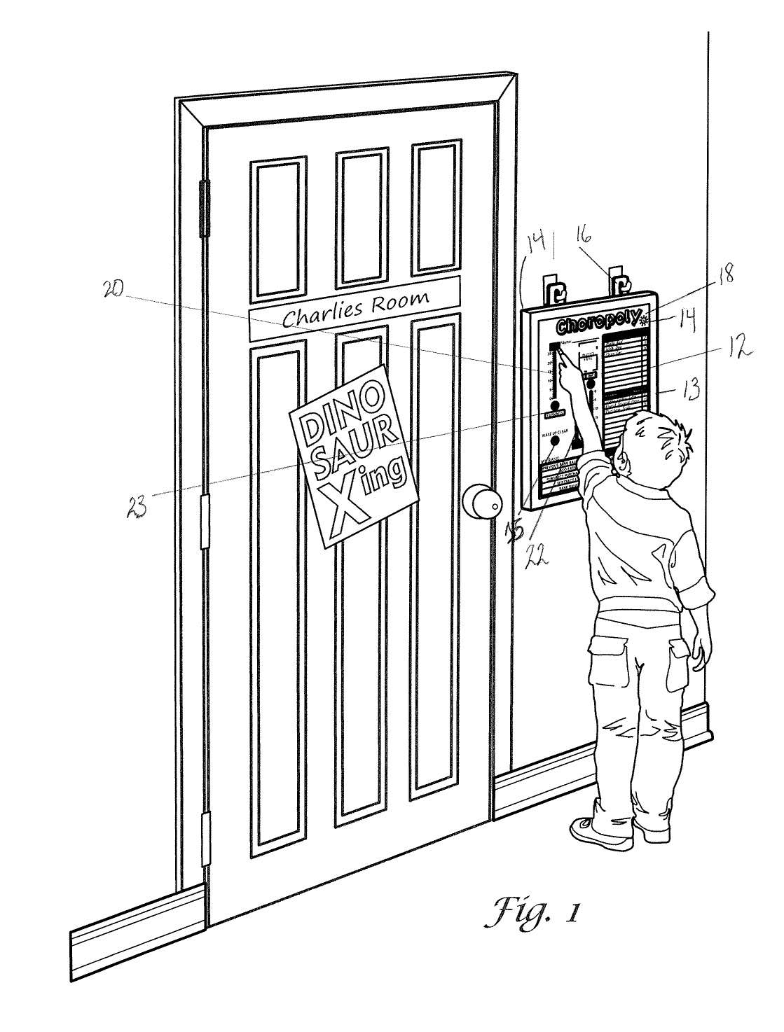

Referring now to FIG. 1 is a view of the interactive incentive based game board system 10. The system 10 includes a front side 12 and back side 14 which may be releasably attached to a wall or various surface using a set of hangers 16 affixed to a top portion 18 of the board which enables the system to be releasably attached to variety of surfaces. The front side of the board 12 includes a set of scales (i.e., accumulators) 20 with one accumulator corresponding and tracking of “earning” and in a first direction and second accumulator tracking of “fines” in a direction opposite the first direction to provide a visual indication to the child of their progress. The integrated microprocessor 13 is used to add the accumulation totals of the earnings, purchases, and fines; provide an audible response through a speaker 14 corresponding to an accumulation, and light at least one of the light emitting diodes 22 when at least one of the push button accumulator switches 15 is depressed.

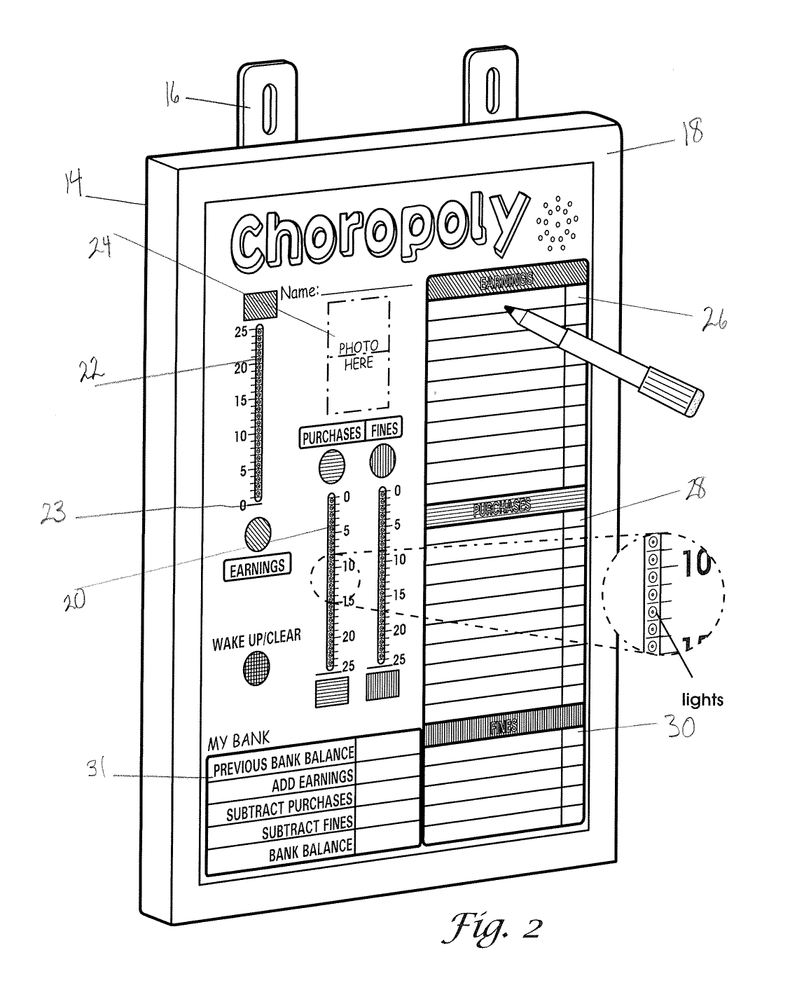

Now shown in FIG. 2 is a view of the front side of the board and a detailed view showing the plurality of light emitting diodes 22 vertically oriented in the first and second directions and extending from zero to twenty-five along each of the accumulators to provide an enhanced visual display which may assist with light recognition for the visually impaired.

Further illustrated is a “purchase” push-button accumulator 15 (i.e., parameter) having a common interval range from zero to twenty-five starting at a zero baseline 23 with the “Earning” and “Fines” scales starting at the zero baseline 23 and extending vertically in opposite directions. The front side 12 further includes a space for the user's picture 24, earnings ledger 26, purchases ledger 28, and fines ledge 30. Further located along a bottom portion of the front surface 32 is the bank ledger 31 wherein a previous balance is listed, new earnings can be added, purchases can be subtracted, fines can be subtracted, and a new balance can be determined. In this regard, a child can keep a running balance and plan for long term purchases. Further illustrated in FIG. 2 is an optional space wherein a user name and picture 24 may be attached to identify the child whom will be using the system 10.

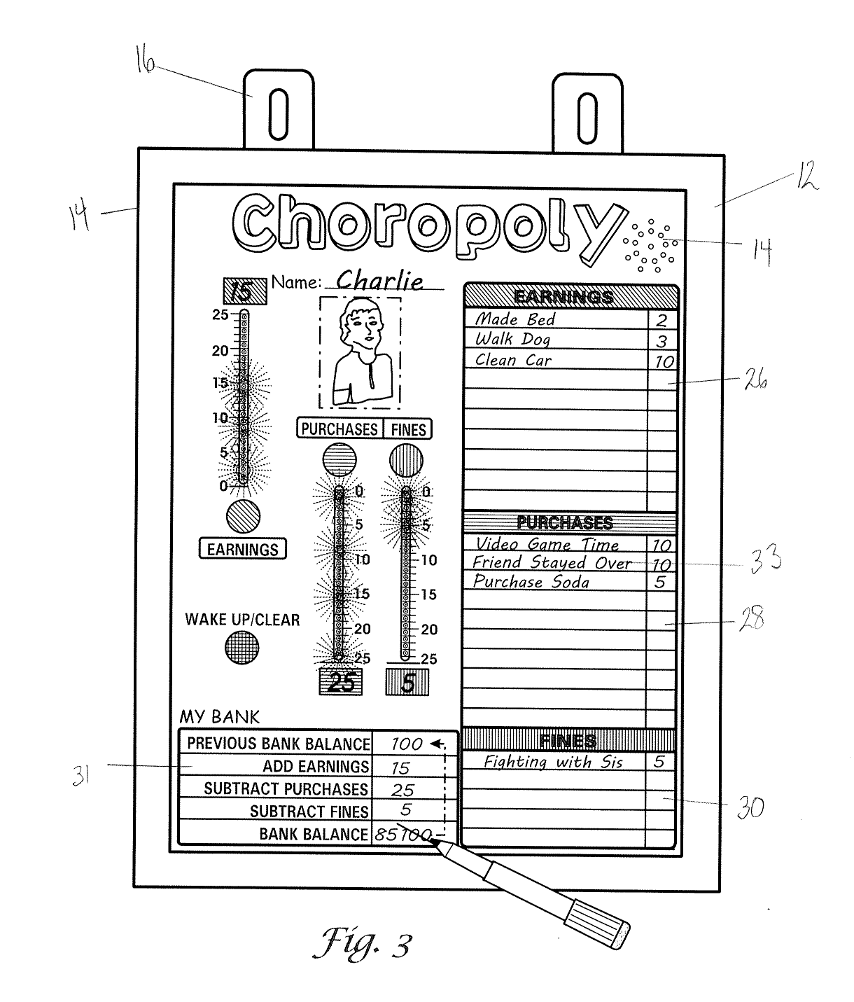

Shown in FIG. 3 is a view of the earnings ledger 26 which allows the user to itemize pre-designated event lists 34, which list events that the child can complete to earn a pre-determined amount. Earnings events may include (but are not limited to) activities such as washing a car, brushing teeth, vacuuming their room, mowing the lawn, or shoveling snow.

The section also has a purchase ledger 28, which lists the items that the child can purchase and the associated purchase amount list 33. Examples of purchases may include but are in no way limited to candy, television watching, movie night, having a friend over, staying up late, etc.

The section further has a fines events ledger 40, which lists the events that will cause the child to lose points and/or amounts. A fines amount list 35 lists the fines associated with each fine event. Examples of fine events include, but are in no way limited to disrespectful behavior, insubordination, talking back, bad report card, etc.

During use, the parent and child first determine earning events and assign pre-selected values thereto within the earning or purchases ledger 26, 28. Next, the purchase events and fine events and their respective values are assigned. It is contemplated that when an event corresponding to an “earning activity” has been completed, the user may depress the push-button switch actuator 15 which simultaneously lights one of the light emitting diodes 22 in a vertical direction up/down and provides an audio indication through the speaker 13. Once a pre-defined activity corresponding to an earning is completed, the parent or child may depress the tactile push-button accumulator to add points to the vertical scale. Conversely, if a fine or purchase has been completed, the child will depress the tactile push-button accumulator switch 15 corresponding to the fine or purchase. The system 10 and microprocessor 13 are configured to receive and count the number of accumulations received and provide a visual indication on one of the three scales provided. Once a score of twenty-five has been accumulated in a given direction, the user may simply wipe off the previous recorded score and replace it with a new counted accumulation.

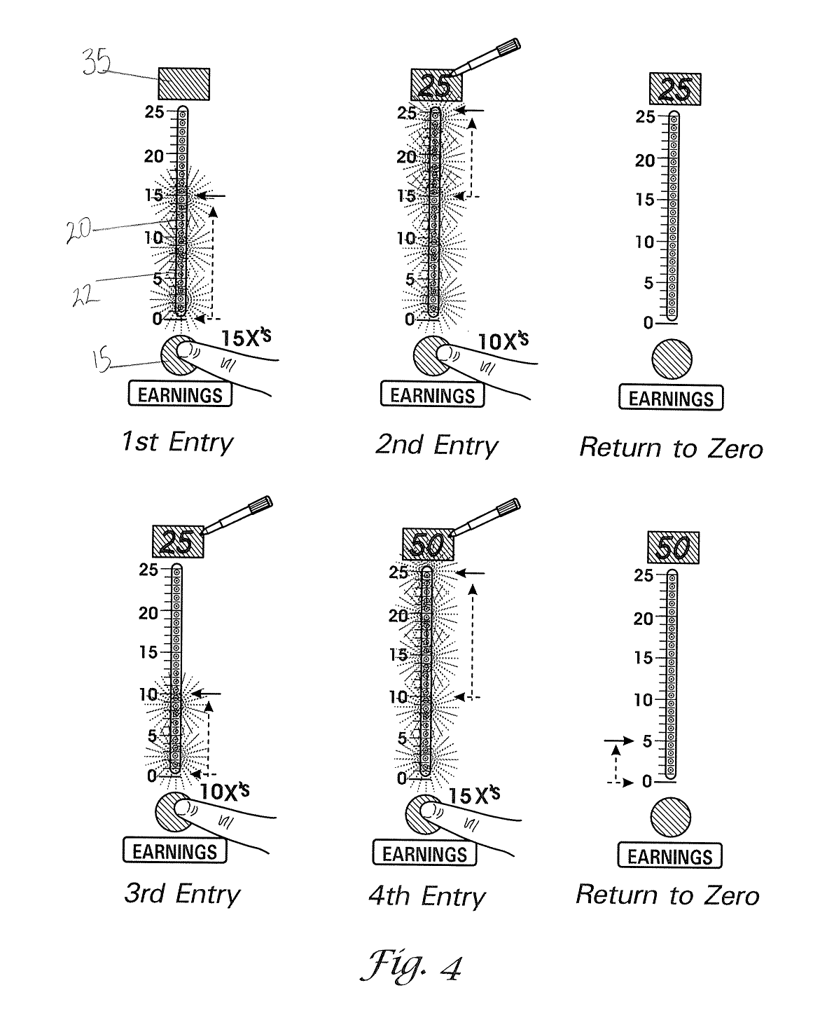

Shown in FIG. 4 is a detailed view of the earning scales 20 with the user depressing the push-button accumulation switch to add to earning scales. Once the scale reaches its maximum limit of twenty-five it may reset to zero and a total score total recorded within an accumulation box 35 located above each of the scales 20. As opposed to traditional 9-digit calculators, the system allows for infinite accumulation by simply replacing the number shown in the accumulation box 35 with a new total.

Shown in FIG. 5 is a detailed view of the purchases and fines scales 20 with the user depressing the push-button accumulation switch which lights the scales in a direction away from the baseline 23. Once the scale reaches its maximum limit of twenty-five it may reset to zero and the purchases/fines total written within the accumulation box 35. Further shown for illustrative purposes is an indication that numbers are subtracted from the earning when a purchase/fine has been indicated.

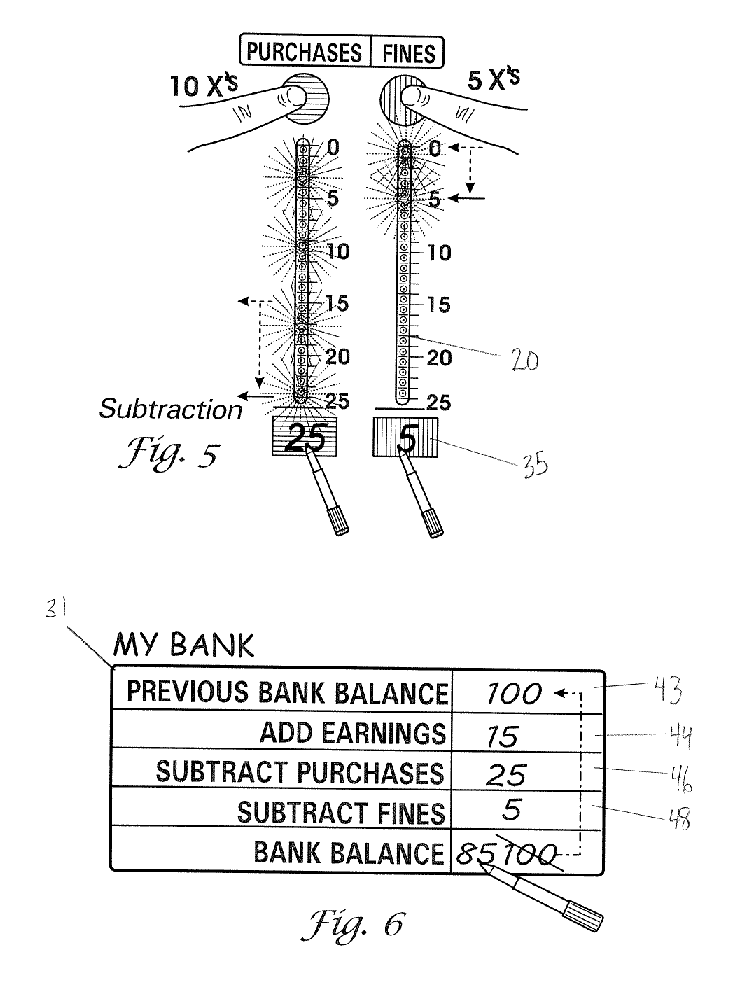

Shown in FIG. 6 is detailed view of the bank ledger 31 which provides an example of how an accumulation may be determined using the categories “previous bank balance 43; add earnings 44; subtract purchases 46; and subtract fines 48.”

It will be appreciated by persons skilled in the art that the present embodiment is not limited to what has been particularly shown and described hereinabove. In addition, unless mention was made above to the contrary, it should be noted that all of the accompanying drawings are not to scale. A variety of modifications and variations are possible in light of the above teachings without departing from the following claims.

What is claimed is:

1. An interactive incentive based game board system to enable and track at least one user defined parameter to a value without a maximum limit over a period of time, the system comprising:
a microprocessor including a memory module in electrical communication with at least one capacitive sensor and configured to record an accumulated balance and provide a visual indication through a translucent portion of the game board;
a customized game board including at least:
a first visual indicator extending from a baseline in a first direction and corresponding to a positive accumulated balance;
a second visual indicator extending outward in a second direction from the baseline and corresponding to a negative accumulate balance;
an erasable balance ledger to record at least a positive accumulated balance and a negative accumulated balance;
a first parameter ledger to define a selected parameter to the positive accumulated balance;
a second parameter ledger to define a selected parameter to the negative accumulated balanced; and
a push-button sensor adjacent to the first and the second visual indicator and configured to notify a user of a change in the positive or the negative accumulated balance by illuminating a number of lights; the number of lights corresponding to the number of times the push-button sensor is depressed.

2. The system of claim 2, wherein the user defined parameter corresponding to a positive accumulated balance is further defined as earnings.

3. The system of claim 1, wherein the user defined parameter corresponding to a negative accumulated balance is further defined as a purchase or a fine.

4. The system of claim 1, wherein the customized game board further includes a reset push-button configured to remove the positive accumulated balance and the negative accumulated balance when depressed for a first pre-selected period of time.

5. The system of claim 4, wherein the reset push-button further enables a low power mode when depressed for a second pre-selected period of time.

6. The system of claim 1, further including at least one speaker configured to provide an audio indication when a balance change to at least one scale has been indicated.

7. The system of claim 1, further providing a plurality of tactile inputs to be received at a portion of the customized game board and accumulated within the microprocessor.

8. An interactive incentive based gaming method which enables a user to record an accumulated balance corresponding to a user defined parameter to a value without a maximum limit, the method comprising:
providing a gaming system including a recordable dry erase top surface and further plurality of push-buttons electrically connected to at least one capacitive sensor and a microprocessor;
enabling a user to select a period from a plurality of available time periods to an embedded timer and providing a first audio notification of an expired period of time at a speaker;
providing a first vertically oriented accumulated balanced indicator comprised of a plurality of colored light emitting diode and extending vertically from a baseline in a first direction; the first vertically oriented accumulated balance corresponding to an earnings balance;
providing a second vertically oriented accumulated balanced indictor comprised of a plurality of colored light emitting diodes and extending vertically outward in a second direction opposite the first direction; the second vertically oriented accumulated balance indicator corresponding to a penalty balance;
defining at least one earnings parameter within an earning ledger portion of the recordable dry erase top surface;
defining at least one penalty parameter within penalty ledger portion of the recordable dry erase top surface;
detecting an input corresponding to a change in balance at the plurality of push-buttons and providing an audio alert;
indicating the change in balance has been received at the capacitive sensor by illuminating a number of light emitting diodes on the first or the second vertically oriented accumulated balance indicator; the number of light emitting diodes corresponding to a number of times a push-button has been depressed;
recording an accumulated balance within a recordable area adjacent to the first or the second vertically oriented accumulated balance indicator when a maximum number light emitting diodes has been illuminated;
resetting the first or the second visual indicator at baseline after the accumulated balance has been recorded to enable an accumulated balance without a maximum limit to be achieved.

9. The assembly of claim 12 wherein:
said first parameter is earnings and said first parameter value is earnings value; said second parameter is purchases and said second parameter value is purchases values; and
said assembly further comprises a fines indicator, said fines indicator representing a fines value, said fines indicator being oriented in said direction.

10. The assembly of claim 13 wherein said first direction and said second direction are vertically oriented relative said baseline.

11. The assembly of claim 12 further comprising a control using a speaker, said speaker providing a distinct audible alert when either of said earned value and said purchased value changes.

12. A method for tracking a first parameter and a second parameter said method comprising the steps:
providing first parameter task and second parameter event;
providing an assembly with:
a first parameter indicator oriented in a first direction and having a first parameter zero value and represents a first parameter value increasing from said first parameter zero value;
a second parameter indicator oriented in a second direction and having a second parameter zero value and represents a second parameter value increasing from said second parameter zero value; and
a baseline, wherein said first parameter zero value and said second parameter zero value are visually aligned at said baseline and said first direction is opposite of said second direction relative said baseline; and
providing an incentive for performing specific tasks represented by the first parameter by adding to the first parameter indicator upon completion of first parameter task; and
allowing the user can visually determine whether there is sufficiently large first parameter value to allow for desired second parameter events, and if so performing a second parameter event and adding a second parameter values to the second parameter value indicator.

13. The method of claim 12, further enabling tactile inputs received at a push-button accumulator to be visually provided using a plurality of light emitting diode vertically oriented along a scale.

14. The method of claim 13, wherein the vertically oriented sales are configured from a common baseline and extend in an opposite direction from said baseline from zero to twenty-five.

15. The method of claim 12, wherein a portion of the customized board game a recorded accumulation to be manually recorded above each of a plurality of accumulation scales.
